(19) United States
(12) Patent Application Publication
(10) Pub. No.: US 2005/0117510 A1
(43) Pub. Date: Jun. 2, 2005

(54) Cell Current ReConstruction Based on Cell Delay and Node Slew Rate

(76) Inventor: Andy Huang, San Jose, CA (US)

Correspondence Address: ANDY HUANG, 2880 ZANKER ROAD, SUITE 203, SAN JOSE, CA, 95134, US

(21) Appl. No.: 10/248,685

(22) Filed: Feb. 7, 2003

Related U.S. Application Data
(60) Provisional application No. 60/319,226, filed on May 3, 2002.

(51) Int. Cl. H04L 12/26

(52) U.S. Cl. 370/229

(57) ABSTRACT

Present invention suggests a method to extract accurate value and time domain of the current in the VLSI circuit, which is almost impossible by the conventional methods. Conventional approaches take the current of a cell as a constant average value extracted by power consumption, which makes designers underestimate peak current and IR-drop of a system. There is no current model considering the cell (or gate) delay and node slew rate even though they are significant factors for the cell current behavior. To re-construct the current waveform efficiently, we divide the cell current into the intrinsic and the output load current. The intrinsic current can be computed with energy value from the power library when the cell becomes active. The load current is computed based on the slew rate, effective start and end time points of the current wave. Instead of using the conventional current information, present invention reconstructs the current information of the design. Due to the accurate current analysis, it has outstanding accuracy to analyze the whole chip precisely in IR drop analysis and peak power analysis.

### CROSS REFERENCE TO RELATED APPLICATIONS

R. Marchulescu, D. Marculescu and M. Pedram, “Switching Activity Analysis Considering Spatiotemporal Correlations”, Proc. of ICCAD, 1994. Ghosh, S. Devades, K. Keutzer, and J. White, “Estimation of Average Switching Activity in Combinational and Sequential Circuits”, Proc. of the 29 DAC, pp. 253-259, June 1992.

### BACKGROUND OF THE INVENTION

A lot of recent VLSI applications are getting larger and faster. Among them, the mobile systems require lower power as more functions are integrated into the system. Generally, the methods to build the low power system are controlling the threshold voltage, or reducing the supply voltage. However, the low power system results in lowering of speed and decreasing the noise immunity, which debases the reliability of the systems.

IR-drop analysis and power (or current) estimation of the design are the major activities for the low power system. Conventionally, the current and IR drop estimation can be obtained with the circuit simulators, such as spice simulator, time-mill or rail-mill by Synopsys. But the problems of estimation lie in the capacity and performance of circuit-level simulators. The circuit level simulators cannot perform the VLSI design if it has more than tens of thousands of transistors. Even though they can provide accurate analysis, these can hardly do full-chip simulation. It takes so much time to simulate SoC full-chip that it cannot be applied to analyzing the recent SoC designs. This is why gate-level power estimation is more acceptable than transistor-level for analyzing SoC design.

In gate-level power estimation, probabilistic methods seemed efficient if we did not consider correlation among signals in the design. Since these techniques treated only density of the transition, we could get only the average value of the power consumption, not any peak one. Instead of the probabilistic method, the switching information of gate-level simulator is-applied to the power analysis. Since the switching period of each component consumes over 90% of total power consumption of each component, the transition activity of each component is an essential factor to analyze the power estimation.

The development of power estimation technique at gate level gives great help to predict the average power consumption of system, because it provides useful accurate information, which is less than 10% error compared with silicon measurement. Although the average value is very meaningful to know about the thermal effect, EM (Electo-Migration) phenomenon, and the required PAD counts, but the peak current of system and IR-drop at the net of component are dominant factors to determine the exact timing violation at the VDSM.

There is a simple technique to get the peak value of the power; dividing the simulation periods into pieces and performing power estimation. However, these values are merely the average current of pieces of simulation periods, and we might miss the peak current value caused by consecutive events. There are few researches to predict the peak system power until now. Our method is to find the active window period and re-construct the current of a cell to find peak power consumption and peak IR-drop value.

### BRIEF DESCRIPTION OF DRAWINGS

FIG. 1. The starting time and the ending time of an event of Z

FIG. 2: (a) extension from event point by slew rate

FIG. 2: (b) result of extension of (a)

FIG. 2: (c) Current window of a cell in case of non-zero interconnect delay

FIG. 3. Adjustment of the current based on the real Vdd and Idd

### DETAILED DESCRIPTION

The Method to Find Current Window from the Events and Delay Calculation of a Cell

It is obvious that switching current of a cell flows only when the cell activates. The power of a cell is the average current in the simulation period. During the simulation period, the peak current value is much larger than the average one because the dormant period of a cell is normally much longer than the active period. To detect the peak current value, we should know the current window period and the total charge quantity. Our basic idea on current window is to employ the event time and slew rates of signals and extends twice to get the accurate starting and ending event time.

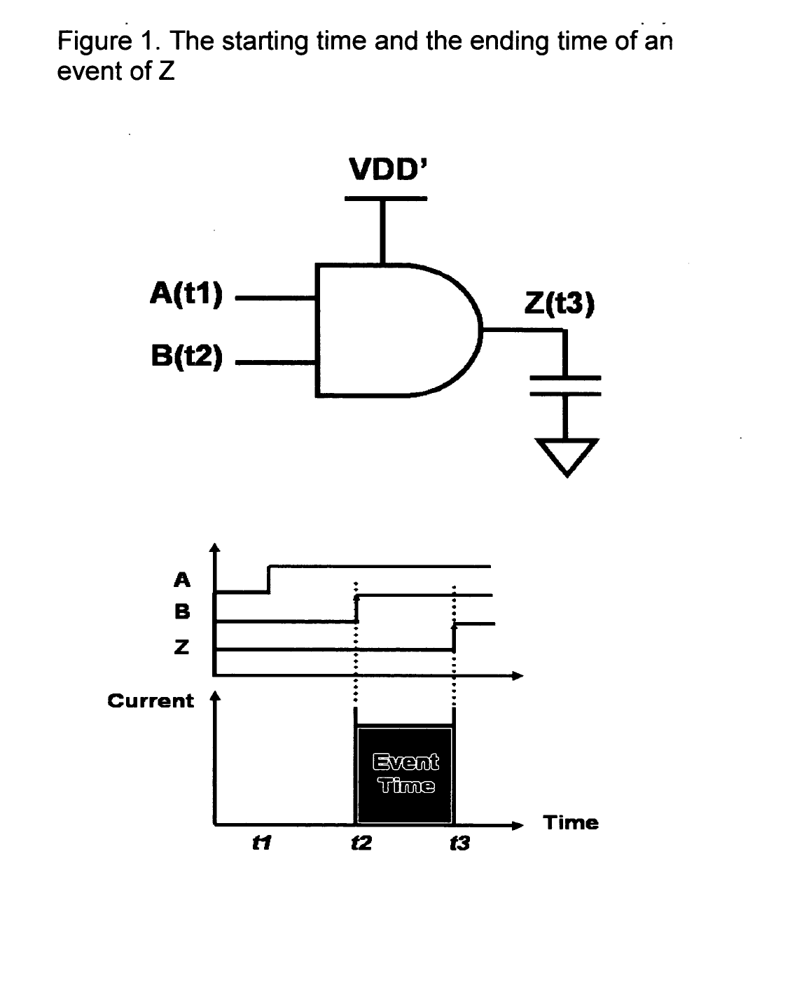

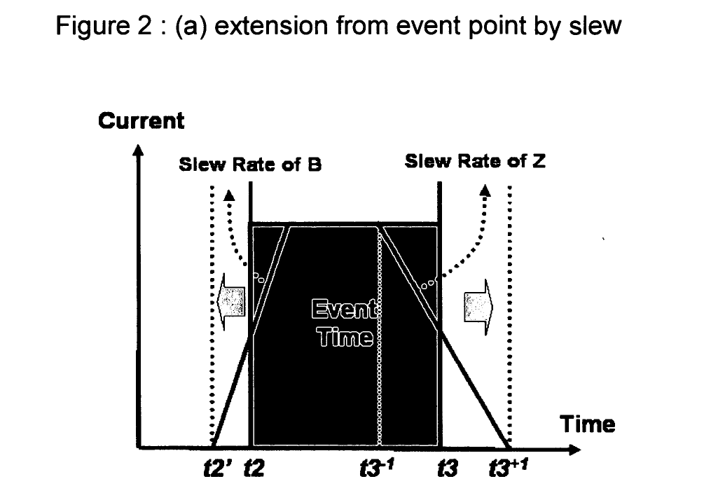

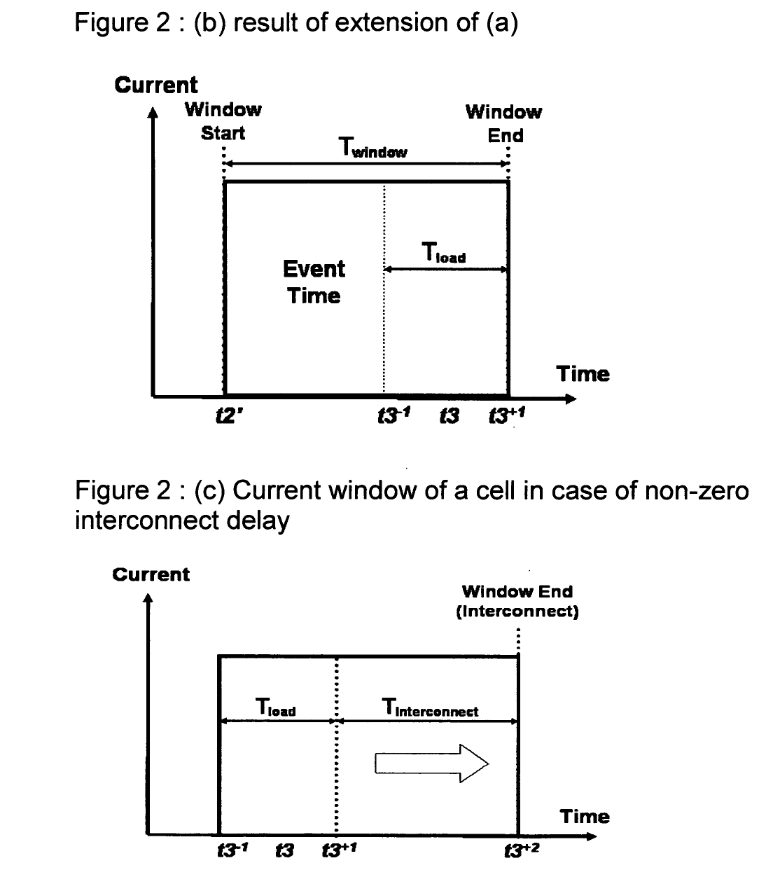

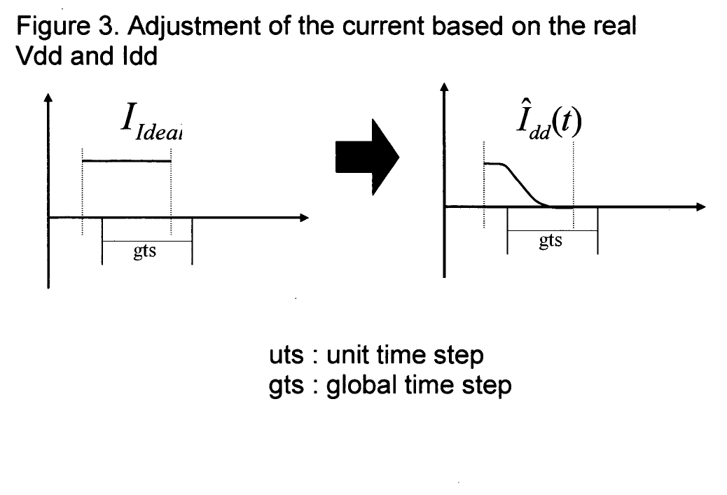

From the result of logic simulator like VCD(Value Change Dump) file, we can get logical starting and ending time point. In FIG. 1, the event of B occurs at t2, which causes the event at Z at t3. It looks like that the t2 and t3 are starting time point and end time point, respectively. However, the signals of B and Z have the transition time, which is called by slew rate computed by delay calculation. To consider the effect of signal transition time, we extend the starting time by the slew rate of B to get t2⁻¹ and the ending time by that of Z to get t3^{+‘}in FIG. 2.

In addition to extension for slew rate of Z, one more extension is performed as shown in FIG. 2-(c) to consider the interconnect delay, which is becoming dominant delay in VLSI designs. After two extensions, we can obtain the whole window (t2⁻¹ and t3⁺²) for an event to arrange the current of a cell. In our approach, there is no current outside current window while the existing method always takes the average current derived by power consumption.

The Method to Construct Current Waveform

In FIG. 1, considering the (vdd) supply node and the current (idd), the idd is divided into intrinsic-current (I_{intrinsic}) and load-current (I_{load}), as shown at FIG. 1. I_{intinsic} can be obtained by the energy value of the event from the power library. The energy value is essential to get the peak-to-peak value of the current. After finding current window, the proposed method finds the I_{intrinsic} is as follows,
1 .Find the power value from the library with slew rate and output load using interpolation
2.Compute the current I_{intrinsic} (t) between events or locate user-defined PWL waveform

In case of knowing the current waveform and calibrating it already, we just lay the current waveform on the activation window. Otherwise, we have to re-construct the current shape keeping the total energy value. The shape is user-defined variable. For simple explanation, we use rectangle shape in this patent. The value E from library is an average energy value when the event occurs at every I ns. So the current value is
E=∫i(t)*v(t)dt=I_{intrinsic}*V_{DD}*T_{window}/1(ns)
where v(t) is constant V_{DD}. Thus the final current value is

$${I}_{intrinsic} = \frac{{V}_{DD}^{*} {T}_{window}^{*} 1.09}{E}$$

at

$${t}_{2}^{- 1} \leq t \leq {t}_{3}^{+ 2} \qquad ( 1 )$$

Note that I_{intrinsic} reflects internal current only. We should re-construct current waveform for load capacitance independently. The load current is computed based on the slew rates, effective start and end rate of the current wave, which is represented by x %-y %. The begin and end charging time pair is computed by the (x, y) pair, the segment is obtained by extending each of the pair to the level 0 and level 1 value, respectively. For example, if the slewrate is 35-65%, (35, 65) the segment of the slope and offset are obtained from the pair (the time of 65%, the time at 35%). And the charging time begins at the cross point of the segment at 0V, and ends at the cross point of the segment at 5V. The charge Q of the cell during the period is as follows,

$$Q = {C}_{eff} V = {\int }_{t 1}^{t 2} i ( t ) ⅆ t = {\int }_{t 1}^{t 2} {i}_{m} ( t ) ⅆ t$$

while t₁ is the time when voltage level 0, and t₂ is the time when voltage level 1. The i(t) is modeled by iₘ(t) which is one of the average value, trigonometry, and diamond shape. For example, if we use average value, the I_{load} is

$$Q = {C}_{eff} V = {\int }_{t 1}^{t 2} i ( t ) ⅆ t = {l}_{load}^{*} Λ T$$

$${I}_{load} = \begin{matrix}{C}_{eff} V \\ {T}_{load}\end{matrix}$$

at

$${t}_{3}^{- 1} \leq t \leq {t}_{3}^{+ 1} \qquad ( 2 )$$

In the post-layout stage, C_{eff} is not equal to Cₜₒₜₐₗ any more because there are resistive properties in interconnect line, which prevent the driver cell from driving all capacitances simultaneously. Thus, there are delay called interconnect delays, T_{interconnect}. In this patent, we think the interconnect capacitance is C_{interconnect}=(CₜₒₜₐₗC_{eff}) simply. Then, the interconnect current is,

$${I}_{interconnect} = \frac{{C}_{interconnect} V}{{T}_{interconnect}}$$

at

$${t}_{3}^{+ 1} \leq t \leq {t}_{3}^{+ 2}$$

The total current of a cell is,
Iₜₒₜₐₗ=I_{cell}(t)+I_{load}(t)+I_{interconnect}(t)

The Simple Current Adjustment Considering the Variation of Non-Ideal Voltage Source

Since the computed current values are obtained from the ideal voltage source, present invention includes the adjustment procedure to have realistic value. The V_{dd} and I_{dd} from the source are sometimes pulled down to the marginal level, due to the long distance or overload, so the analysis should concern the dirty V_{dd} and I_{dd} to get the correct and realistic result. The adjustment procedure is based on the following mathematical background. By using the voltage value of previous time step, we compute a new current value,
i_{dd}(t)=I_{Ideal}={V_{dd}(t−uts)/V_{Ideal }}²
where uts is unit time step.

Present invention emphasizes on not only the power value of a cell (or a gate), but also the activation time to figure out the current waveform of a cell(or gate). The accurate analysis of cell current is fundamental to examine peak system current and peak IR-drop. By constructing the cell current of a design, we can get the peak system power by just summation of cell current at each time point

1. A method to construct an activation window for a cell
We suggest a method to get the window activating a cell from the information: event time, cell delay, interconnection delay, and slew rate. First, we catch an event of a cell from the results of logic simulation. Then, we find the period when the cell activates by computing interconnect delays of the output loads.

2. A method to re-construct the current waveform in the activation window
Characterization of current is so complex because the value of current is affected by characteristics of the design, design-by-design, adjacent cells, number of inputs and outputs, operating environment, etc. These complex and dynamic natures of the current value cannot be obtained from todays power library, which gives a total energy of event. So, we need careful reconstruction of cell current behavior. To find the current value in the SoC, we divide the current of a cell into two components: intrinsic current and load current. While the load current is computed by charge conservation, the intrinsic current can be computed with combination of power library and delay calculation. The composition of the intrinsic and load current becomes closer to real current behavior of cell than the current by conventional method. Moreover, if designers have the real PWL current waveform, we can locate the real current in our activation window to get more accurate results.
